(19) United States
(12) Patent Application Publication
(10) Pub. No.: US 2018/0082416 A1
(43) Pub. Date: Mar. 22, 2018

(54) SYSTEMS AND METHODS FOR ANALYZING IMAGE QUALITY

(71) Applicant: QUALCOMM Incorporated, San Diego, CA (US)

(72) Inventors: Veluppillai Arulesan, Toronto (CA); Shiu Wai Hui, Richmond Hill (CA); Stewart Chao, Markham (CA)

(21) Appl. No.: 15/267,625

(22) Filed: Sep. 16, 2016

(51) Int. Cl. G06T 7/00; H04N 5/232; G06T 1/20

(52) U.S. Cl. CPC G06T 7/0002; H04N 5/23293; G06T 2207/30168; G06T 1/20; H04N 5/23216

(57) ABSTRACT

A method is described. The method includes selecting a camera block or a graphics processing unit (GPU) to analyze an image for image quality upon capturing the image by a camera on a mobile device. The method also includes analyzing the image for image quality based on the camera block or GPU selection. The method further includes generating a user notification upon detecting one or more problems with the image based on the image quality analysis.

### TECHNICAL FIELD

The present disclosure relates generally to communications. More specifically, the present disclosure relates to systems and methods for analyzing image quality.

### BACKGROUND

In the last several decades, the use of mobile devices has become common. In particular, advances in electronic technology have reduced the cost of increasingly complex and useful mobile devices. Cost reduction and consumer demand have proliferated the use of mobile devices such that they are practically ubiquitous in modern society. As the use of mobile devices has expanded, so has the demand for new and improved features of mobile devices. More specifically, mobile devices that perform new functions and/or that perform functions faster, more efficiently or more reliably are often sought after.

Advances in technology have resulted in smaller and more powerful mobile devices. For example, there currently exist a variety of mobile devices such as portable wireless telephones (e.g., smartphones) personal digital assistants (PDAs), laptop computers, tablet computers and paging devices that are each small, lightweight, and can be easily carried by users.

A mobile device may be configured with a camera. A user may capture one or more images of a scene using the camera. Problems may occur in the captured image. For example, the image may be blurry, a desired area (e.g., face) may be out-of-focus, or the image may be misaligned. If the user does not manually check the image for image quality, the user may lose the opportunity to retake the photo. However, manual image quality analysis is time-consuming and cumbersome on a mobile device. As can be observed from this discussion, systems and methods for automatically analyzing image quality and notifying a user of detected problems may be beneficial.

### SUMMARY

A method is described. The method includes selecting a camera block or a graphics processing unit (GPU) to analyze an image for image quality upon capturing the image by a camera on a mobile device. The method also includes analyzing the image for image quality based on the camera block or GPU selection. The method further includes generating a user notification upon detecting one or more problems with the image based on the image quality analysis.

Selecting a camera block or a GPU to analyze an image for image quality may include querying the camera block to determine what image quality metrics the camera block supports. Querying the camera block may include sending an application program interface (API) call to the camera block. A flag may be received that indicates the image quality metrics the camera block supports.

Selecting a camera block or a GPU to analyze an image for image quality may include checking a preconfigured lookup table that lists the image quality metrics the camera block can perform.

If the camera block is able to perform the image quality analysis, the camera block may be selected to analyze the image for image quality. Otherwise, the GPU may be selected to analyze the image for image quality.

Analyzing the image may include analyzing the image for at least one of blurriness, out-of-focus areas or a misaligned horizon in the image. The image quality analysis may occur as a background operation on the mobile device.

Generating the user notification may include displaying a message that describes the one or more detected problems with the image. Generating the user notification may further include highlighting one or more areas of the image that are determined to have a problem.

If the GPU is selected to analyze the image, the GPU may analyze the image for image quality using fast Fourier to determine blurriness of the image. If the GPU is selected to analyze the image, the method may also include partitioning image data into bins. The bins may be sent the GPU to determine local blurriness associated with the bins.

The method may also include performing corrections on the image for user approval based on the image quality analysis.

A mobile device is also described. The mobile device includes a processor, a memory in communication with the processor and instructions stored in the memory. The instructions are executable by the processor to select a camera block or a GPU to analyze an image for image quality upon capturing the image by a camera on the mobile device. The instructions are also executable to analyze the image for image quality based on the camera block or GPU selection. The instructions are further executable to generate a user notification upon detecting one or more problems with the image based on the image quality analysis.

A computer-program product is also described. The computer-program product includes a non-transitory computer-readable medium having instructions thereon. The instructions include code for causing a mobile device to select a camera block or a GPU to analyze an image for image quality upon capturing the image by a camera on the mobile device. The instructions also include code for causing the mobile device to analyze the image for image quality based on the camera block or GPU selection. The instructions further include code for causing the mobile device to generate a user notification upon detecting one or more problems with the image based on the image quality analysis.

An apparatus is also described. The apparatus includes means for selecting a camera block or a GPU to analyze an image for image quality upon capturing the image by a camera on a mobile device. The apparatus also includes means for analyzing the image for image quality based on the camera block or GPU selection. The apparatus further includes means for generating a user notification upon detecting one or more problems with the image based on the image quality analysis.

### BRIEF DESCRIPTION OF THE DRAWINGS

FIG. 1 is a block diagram illustrating a mobile device configured to automatically analyze an image captured from a camera for quality using a camera block or a graphics processing unit (GPU);

FIG. 2 is a flow diagram illustrating one configuration of a method for analyzing image quality;

FIG. 3 is a flow diagram illustrating another configuration of a method for analyzing image quality;

FIG. 4 is an example illustrating a user notification generated according to the described systems and methods;

FIG. 5 is an example illustrating image quality analysis and a user notification generated according to the described systems and methods;

FIG. 6 is another example illustrating image quality analysis and a user notification generated according to the described systems and methods;

FIG. 7 is yet another example illustrating image quality analysis and a user notification generated according to the described systems and methods; and

FIG. 8 illustrates certain components that may be included within a mobile device.

### DETAILED DESCRIPTION

While taking a photo with a mobile device (e.g., smartphone or camera), a typical user workflow involves opening the image after capturing the image to manually check for image quality. For example, a user may manually check for blurriness and other metrics in the captured image. This is a painful process because a user typically has to zoom in to check for sharpness, which may be difficult on a small display screen of the mobile device. However, if this process is not done, the user may not detect a poor photo until well after taking the photo. It is quite possible that it may no longer be feasible to retake a photo with similar environmental conditions. For example, a user may not be able to get back to the same location (e.g., vacation photos), or the photo may rely on lighting that occurs at a certain time of day. In this case, the opportunity would be lost.

The systems and methods described herein provide for automatic image quality analysis and user notification. A mobile device may use a camera block or graphics processing unit (GPU) to automatically analyze an image captured by the camera on the mobile device for quality of image. The image quality metrics that may be analyzed include blurriness, out-of-focus areas (e.g., faces), a misaligned (e.g., crooked) horizon, over-exposure and other metrics. The mobile device may alert the user of quality problems when the analysis is complete.

The entire process may happen asynchronously with normal user operation of the mobile device. For example, the mobile device may post a warning only if quality is determined to be poor. As a result, the image quality analysis procedure does not intrude on the user and does not block the user from continuing to use the mobile device. However, the image quality analysis will happen quickly enough for the user to re-capture an image if poor photo quality is detected.

The systems and methods described herein may be implemented on a variety of different mobile devices. Examples of mobile devices include general purpose or special purpose computing system environments or configurations, handheld or laptop devices, multiprocessor systems, microprocessor-based systems, programmable consumer electronics, network PCs, minicomputers, mainframe computers, distributed computing environments that include any of the above systems or devices and the like. The systems and methods may also be implemented in mobile devices such as phones, smartphones, wireless headsets, personal digital assistants (PDAs), ultra-mobile personal computers (UMPCs), mobile Internet devices (MIDs), etc. The following description refers to mobile devices for clarity and to facilitate explanation. Those of ordinary skill in the art will understand that a mobile device may comprise any of the devices described above as well as a multitude of other devices.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

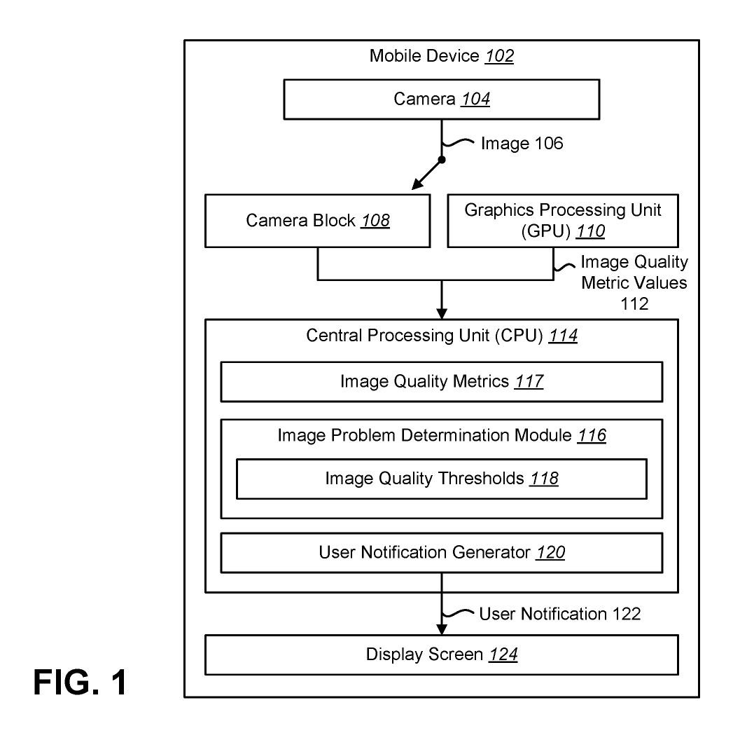

FIG. 1 is a block diagram illustrating a mobile device 102 configured to automatically analyze an image 106 captured from a camera 104 for quality using a camera block 108 or a graphics processing unit (GPU) 110. The mobile device 102 may also be referred to as a wireless communication device, a mobile device, mobile station, subscriber station, client, client station, user equipment (UE), remote station, access terminal, mobile terminal, terminal, user terminal, subscriber unit, etc. Examples of mobile devices 102 include laptop computers, cellular phones, smartphones, e-readers, tablet devices, gaming systems, cameras, etc. Some of these devices may operate in accordance with one or more industry standards.

The mobile device 102 may include a central processing unit (CPU) 114. The CPU 114 may be an electronic circuit that carries out instructions of a computer program. The CPU 114 may implement instructions of the operating system (OS) of the mobile device 102. The CPU 114 may also be referred to as a processor. The instructions executed by the CPU 114 may be stored in memory. The CPU 114 may control other subsystems of the mobile device 102.

The mobile device 102 may also be configured with a camera 104. The camera 104 may include an image sensor and an optical system (e.g., lenses) that focuses images of objects that are located within the field of view of the optical system onto the image sensor. The camera 104 may be configured to capture digital images 106.

Although the present systems and methods are described in terms of a captured digital image 106, the techniques discussed herein may be used on any digital image sequence. Therefore, the terms video frame and digital image 106 may be used interchangeably herein.

The mobile device 102 may also include a camera software application and a display screen 124. When the camera software application is running, images 106 of objects that are located within the field of view of the camera 104 may be recorded by the image sensor. The images 106 that are being recorded by the image sensor may be displayed on the display screen 124. These images 106 may be displayed in rapid succession at a relatively high frame rate so that, at any given moment in time, the objects that are located within the field of view of the camera 104 are displayed on the display screen 124.

The mobile device 102 may also be configured with a camera block 108 and a graphics processing unit (GPU) 110. The camera block 108 may be an electronic circuit for processing images 106 captured by the camera 104. In an implementation, the camera block 108 may be a separate silicon block aside from the GPU 110. The camera block 108 may be implemented as a system-on-chip (SOC). The camera block 108 may have circuits specifically configured for image processing at a lower power. These image processing operations may include focus detection, blurriness, and other quality metrics. Therefore, the mobile device 102 may take advantage of hardware optimization provided by the onboard hardware of the camera block 108.

The GPU 110 is an electronic circuit that is also configured to process images. The GPU 110 may be optimized to perform rapid mathematical calculations for the purpose of rendering images 106. For example, the GPU 110 may perform fast Fourier transforms on image data. While the camera block 108 may be primarily configured to perform image quality operations on images 106 captured by the camera 104, the GPU 110 may be configured to perform more general image processing on the mobile device 102. For example, the GPU 110 may perform video processing or 3D processing.

The mobile device 102 may use the GPU 110 to perform image processing operations instead of the CPU 114. Image processing operations are difficult (i.e., taxing) for a CPU 114 to perform. If performed by a CPU 114, these image processing operations may be slow and may result in significant energy drain, which is a concern with battery-powered mobile devices 102. Because the GPU 110 is designed for image processing, the mobile device 102 will run more efficiently by performing image processing with the GPU 110.

Problems may occur while capturing an image 106 using the mobile device 102. While a user is taking a photo with a smartphone or camera, one of the current workflows includes the user opening the image 106 after it is captured and then performing a manual image quality analysis. For example, the user may check the image 106 for image quality, such as blurriness and other quality metrics. This procedure may be cumbersome and frustrating for the user. For example, the user typically has to zoom in to check for sharpness or other image quality metrics. This may be difficult to perform on a mobile device 102 with a small display screen 124.

However, if this image quality analysis is not done, the user may not detect a poor photo until well after taking the image 106. In this case, it is likely that the photo cannot be retaken with similar environmental composition and the opportunity would be lost. This may be especially important for photos where it is difficult or impossible to retake the photo. For example, photos of a certain time of day, vacation photos and photos of children may be fleeting. It is important to capture a high quality image 106 while the opportunity presents itself.

The systems and methods described herein perform automatic image quality analysis to quickly notify the user of the mobile device 102 about potential problems with an image 106. The user can then choose to retake the image 106 while the setting is still available. The described systems and methods also optimize the efficiency of the image quality analysis by determining whether the camera block 108 can perform the analysis.

Upon capturing an image 106 using the camera 104, the mobile device 102 may select either the camera block 108 or the GPU 110 to analyze the image 106 for image quality. The mobile device 102 may use either the GPU 110 or the camera block 108 to automatically analyze the captured image 106 for one or more image quality metrics 117. The image quality metrics 117 may include blurriness, out-of-focus (e.g., a face may be out of focus), misaligned horizon, over-saturation and other metrics. The mobile device 102 may then alert the user of quality problems when the image analysis is complete.

The entire image analysis process may happen asynchronously. In other words, the GPU 110 or the camera block 108 may analyze the image 106 as a background operation while the user continues to perform normal operations on the mobile device 102. For example, the user may use the mobile device 102 for other activities while the GPU 110 or the camera block 108 performs the image quality analysis. When the image quality analysis is complete, the mobile device 102 may post a warning if quality is determined to be poor. As a result this image analysis process is not intrusive on the user and does not block the user from continuing to use the mobile device 102. However, the image quality analysis will happen quickly enough for the user to recapture an image 106 if a poor quality photo is detected.

The CPU 114 may be configured with an image problem determination module 116. The image problem determination module 116 may coordinate the image quality analysis for one or more image quality metrics 117. These image quality metrics 117 may include one or more of blurriness, out-of-focus, misaligned horizon, over-exposure. The image quality metrics 117 may be configurable by the user. In the case of over-exposure, a bi-modal histogram is used to detect over-exposure in a photo (e.g., one segment of the image 106 may be bright white and another dark black).

In an approach, the CPU 114 may detect that an image 106 has been captured by the camera 104. In response to capturing the image 106, the CPU 114 may determine whether the camera block 108 can perform an image quality analysis for the configured image quality metrics 117. The CPU 114 may query the camera block 108 to determine what image quality metrics 117 the camera block 108 supports. For example, the CPU 114 may make an application program interface (API) call to the camera block 108 to determine whether the camera block 108 can perform the image quality analysis for the configured image quality metrics 117.

The API call to the camera block 108 may return a flag that indicates the capabilities that the camera block 108 possesses. For example, the camera block 108 may indicate that it can perform autofocus detection, but not blurriness detection.

Alternatively, the CPU 114 may be pre-configured with knowledge of which image quality metrics 117 the camera block 108 can perform. For example, the CPU 114 may include a preconfigured lookup table that lists the image quality metrics 117 the camera block 108 can perform. The CPU 114 may check this lookup table to determine whether the camera block 108 can perform the image quality analysis for one or more image quality metrics 117.

If the CPU 114 determines that the camera block 108 can perform the image quality analysis for the configured image quality metrics 117, then the CPU 114 selects the camera block 108. In some cases, the camera block 108 may perform the image quality analysis more efficiently than the GPU 110. In these cases, it may be beneficial to prioritize the camera block 108 ahead of the GPU 110. When selected for image quality analysis, the raw image data from the camera 104 may be provided to the camera block 108. The camera block 108 may then perform the image quality analysis for the one or more image quality metrics 117.

However, in some cases, the camera block 108 may not support analysis of one or more configured image quality metrics 117. If the CPU 114 determines that the camera block 108 cannot perform analysis of one or more configured image quality metrics 117, then the CPU 114 may select the GPU 110 for image quality analysis. In other cases, the mobile device 102 may not include a camera block 108. In these cases, the mobile device 102 may also select the GPU 110 for image quality analysis for the one or more image quality metrics 117.

In an implementation, if the camera block 108 cannot perform the image quality analysis, the GPU 110 may use fast Fourier transforms to determine the frequencies present in the image 106. The GPU 110 may provide these image quality metric values 112 (i.e., the frequencies) to the CPU 114. The CPU 114 may use the absence of high frequencies to determine the blurriness of the image 106. This will allow the CPU 114 to detect images that are blurry because of shaking.

In another implementation, the image 106 may be partitioned into smaller bins before being sent to the GPU 110 for image quality analysis. In this case, the GPU 110 may analyze the blurriness of various windows of the image 106. The CPU 114 may then determine the local blurriness of the various windows. This will allow the CPU 114 to present to the user the segments of the image 106 that are actually in focus and the areas that are out of focus. This allows the user to decide if the focus of the image 106 is undesirable.

Upon performing the image quality analysis, the camera block 108 or the GPU 110 may provide the results of the analysis in the form of image quality metric values 112. In an implementation, the camera block 108 or the GPU 110 may provide the image quality metric values 112 in the form of a matrix of values. For example, the matrix of image quality metric values 112 may correspond to small regions of the image 106 (e.g., an 8×8 pixel square of the image 106). This may provide an efficient compression effect for the CPU 114. The image quality metric value 112 for the region is provided in the matrix, which may then be further processed by the CPU 114 to determine problem areas.

Upon receiving the image quality metric values 112, the image problem determination module 116 may detect whether there are one or more problems with the image 106. For example, the image problem determination module 116 may compare the image quality metric values 112 to image quality thresholds 118. In an example, if the image quality metric values 112 for blurriness are above the image quality threshold 118 for blurriness, then the image problem determination module 116 may determine that the image 106 has a problem with blurriness. Alternatively, if the image quality metric values 112 for blurriness are below the image quality threshold 118 for blurriness, then the image problem determination module 116 determines that the image 106 does not have a problem with blurriness.

The image quality thresholds 118 may be configurable by the user. The image quality thresholds 118 may correspond to the configured image quality metrics 117. For example, each of the configured image quality metrics 117 may have an associated image quality threshold 118. The user may configure the image quality thresholds 118 to indicate an allowable amount for the configured image quality metrics 117. For example, the user may configure how blurry, out-of-focus, or misaligned an image 106 may be before the mobile device 102 warns the user. The image quality thresholds 118 may be pre-configured by the user before the mobile device 102 performs the image quality analysis procedure on a captured image 106.

In an implementation, the image problem determination module 116 may perform facial detection to determine whether a face in a photo is out-of-focus. For example, the image problem determination module 116 may detect where a face is in the image 106. Then, using the image quality metric values 112 provided by the camera block 108 or the GPU 110, the image problem determination module 116 may determine whether the face is out-of-focus. The image problem determination module 116 may compare an out-of-focus face with an associated image quality threshold 118 to determine if there is a problem of which the user should be made aware.

In an implementation, the mobile device 102 may perform corrections on the image 106 for user approval based on the image quality analysis. If the mobile device 102 can correct an image 106, then this reduces the need to go back and retake the image 106. After performing the image quality analysis and determining that there is a problem with the image 106, the mobile device 102 may perform one or more corrections to the image 106. For example, the mobile device 102 may clean up blurriness or apply a sharpening process to the image 106. The mobile device 102 may also even out the histogram of the image 106. The mobile device 102 may save a copy of the original image 106 and present the corrected image to the user for approval. In an implementation, the types and amount of correction performed automatically by the mobile device 102 may be pre-configured by the user.

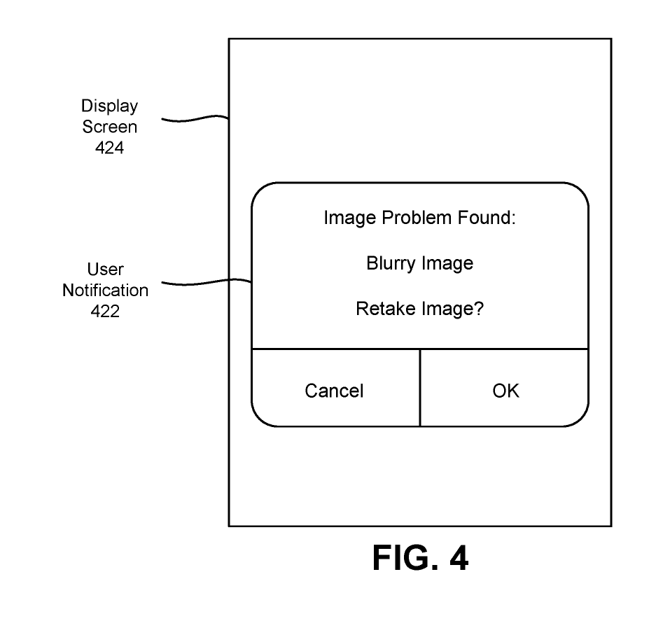

The CPU 114 may include a user notification generator 120 that generates a user notification 122 upon detecting one or more problems with the image 106. In an implementation, the user notification 122 may include a message that describes the one or more detected problems with the image 106. The message may be displayed on the display screen 124. For example, the user notification 122 may warn the user that the image 106 is blurry. Examples of different user notifications 122 that may be generated according to the systems and methods described herein are described in connection with FIGS. 4-7.

The user notification 122 may be displayed to the user in the form of a pop-up message, a notification bar or other graphical user interface (GUI) element that is displayed on the display screen 124. The user notification 122 may indicate that the image 106 has detected quality problems. The user notification 122 may also be accompanied by an audible alert to further warn the user of problems with the image 106.

In an implementation, a user may interact with the user notification 122. The user notification 122 may include an option to retake the image 106. If the user selects this option, the mobile device 102 may bring up the camera software application on the display screen 124. The user may then recapture the image 106. The user notification 122 may also include an option to keep the image 106 without retaking another image.

In an implementation, the user notification 122 may display the image 106. The user may review the image 106 in the user notification 122 to determine whether to retake the image 106.

In yet another implementation, the problem areas on the image 106 may be highlighted in the user notification 122. For example, an out-of-focus face may be highlighted in the image 106 displayed in the user notification 122. The highlighting may assist the user in interpreting the problems that the mobile device 102 has identified. The highlighting may include a shaded area that is superimposed over the problem found in the image 106. Alternatively, the highlighting may include a boundary (e.g., dashed line) that surrounds the problem areas.

In another implementation, the user notification 122 may present proposed corrections that the mobile device 102 has made to the image 106. If the mobile device 102 makes any corrections based on the image quality analysis, the user notification 122 may present the corrected image to the user. The user may choose to accept or discard the corrections.

The systems and methods described herein provide a beneficial image quality analysis and user notification 122. A user will be able to capture an image 106 and continue to use the mobile device 102 for normal operations, confident that the mobile device 102 will provide an alert if a problem is found with the image 106. The described systems and methods are not intrusive on the user and do not block the user from continuing. However, if a problem in an image 106 is found, a user notification 122 is generated quickly enough for the user to re-capture an image 106 before the opportunity is lost.

The described systems and methods also provide for improved efficiency of the mobile device 102. By determining whether the camera block 108 can perform the image quality analysis, the mobile device 102 may reduce the energy consumed by the image quality analysis. However, if the camera block 108 cannot perform the image quality analysis, the mobile device 102 may still benefit from using hardware optimizations of the GPU 110.

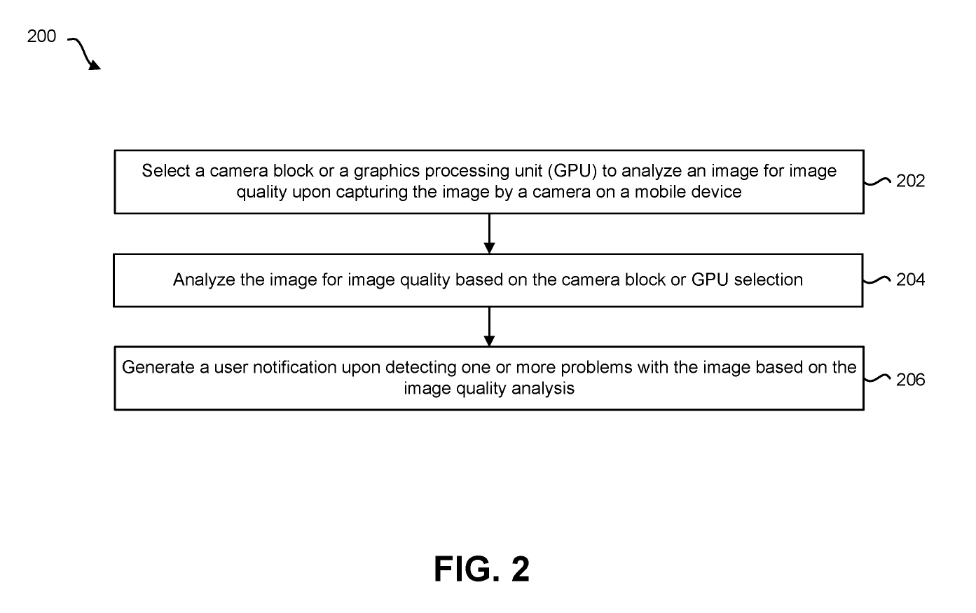

FIG. 2 is a flow diagram illustrating one configuration of a method 200 for analyzing image quality. The method 200 may be performed by a mobile device 102. In an implementation, the mobile device 102 may be configured with a camera 104, a camera block 108, a GPU 110 and a CPU 114.

The mobile device 102 may select 202 the camera block 108 or GPU 110 to analyze an image 106 for image quality upon capturing the image 106 by the camera 104. For example, the mobile device 102 may determine whether the camera block 108 is able to perform an image quality analysis for one or more image quality metrics 117. This may include making an API call to the camera block 108 to determine which image quality metrics 117 the camera block 108 is capable of analyzing. The image quality metrics 117 may include one or more of blurriness, out-of-focus areas or a misaligned horizon in the image 106.

If the camera block 108 is able to perform the image quality analysis, then the mobile device 102 may select 202 the camera block 108 to analyze the image 106 for image quality. Otherwise, the mobile device 102 may select 202 the GPU 110 to analyze the image 106 for image quality. Furthermore, if the mobile device 102 does not include a camera block 108, then the mobile device 102 may select 202 the GPU 110 for the image quality analysis.

The mobile device 102 may analyze 204 the image 106 for image quality based on the camera block 108 or GPU 110 selection. The image quality analysis may occur as a background operation on the mobile device 102. For example, if the camera block 108 is selected, then the mobile device 102 may send the raw image 106 data to the camera block 108 for analysis. The camera block 108 may provide image quality metric values 112 for the analyzed image quality metrics 117.

If the GPU 110 is selected 202 to analyze 204 the image 106 for image quality, then the mobile device 102 may send the raw image 106 data to the GPU 110 for analysis. In an implementation, the GPU 110 may analyze 204 the image 106 for image quality using fast Fourier transforms to determine frequencies present in the image 106. An absence of high frequencies in the image 106 may be used to determine blurriness of the image 106.

In another implementation, the mobile device 102 may partition the image 106 data into bins before sending the image 106 to the GPU 110. The GPU 110 may then analyze the bins to determine local blurriness associated with the bins.

The mobile device 102 may generate 206 a user notification 122 upon detecting one or more problems with the image 106 based on the image quality analysis. For example, the camera block 108 and the GPU 110 may provide image quality metric values 112 to the CPU 114. The CPU 114 may detect one or more problems with the image 106 by comparing the image quality metric values 112 to image quality thresholds 118.

If one or more problems with the image 106 are detected, then the mobile device 102 may generate 206 a user notification 122. Generating 206 the user notification 122 may include displaying a message that describes the one or more detected problems with the image 106. Generating 206 the user notification 122 may also include highlighting one or more areas of the image 106 that are determined to have a problem.

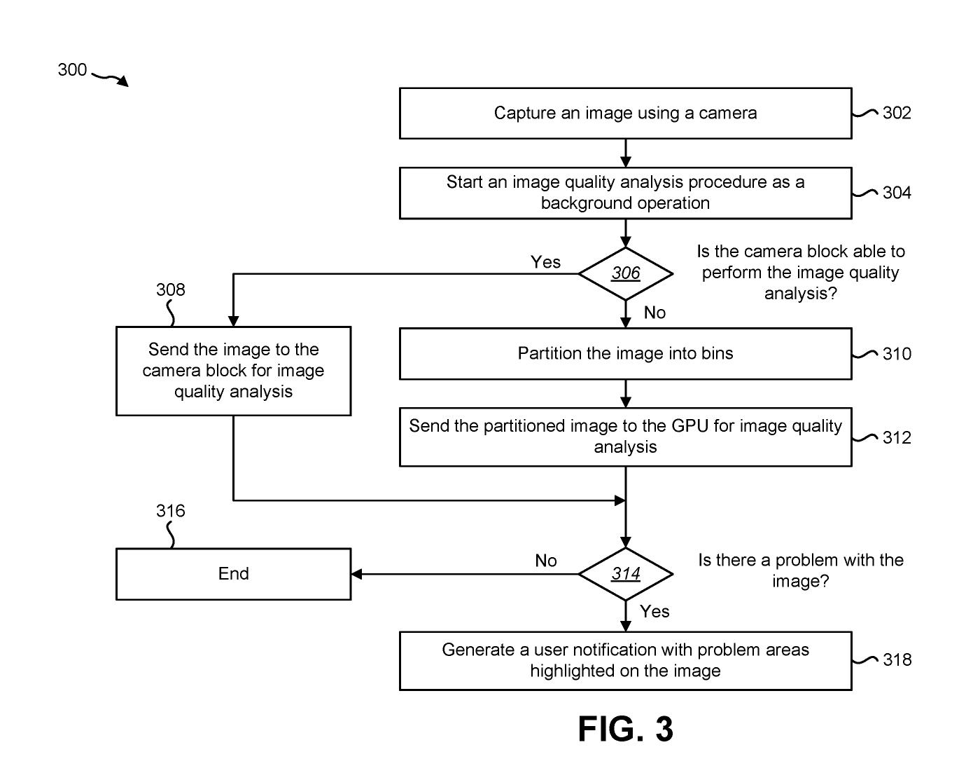

FIG. 3 is a flow diagram illustrating another configuration of a method 300 for analyzing image quality. The method 300 may be performed by a mobile device 102. In an implementation, the mobile device 102 may be configured with a camera 104, a camera block 108, a GPU 110 and a CPU 114.

The mobile device 102 may capture 302 an image 106 using the camera 104. For example, a user may choose to capture an image 106 using the camera 104 of the mobile device 102.

Upon capturing the image 106, the mobile device 102 may start 304 an image quality analysis procedure as a background operation. The user may continue to use the mobile device 102 for normal operations. This user activity may include taking additional images 106 or performing other operations using the mobile device 102. The image quality analysis procedure may run asynchronously with the user activity.

The mobile device 102 may determine 306 whether the camera block 108 is able to perform the image quality analysis. The mobile device 102 may have pre-configured image quality metrics 117 that are to be analyzed. The image quality metrics 117 may include one or more of blurriness, out-of-focus areas or a misaligned horizon in the image 106, etc. The mobile device 102 may check to determine whether the camera block 108 is capable of performing the image quality analysis for the one or more image quality metrics 117.

If the mobile device 102 determines 306 that the camera block 108 is capable of performing the image quality analysis, then the mobile device 102 may send 308 the image 106 to the camera block 108 for image quality analysis. Upon performing the image quality analysis, the camera block 108 may provide image quality metric values 112 for the analyzed image quality metrics 117. For example, the camera block 108 may provide blurriness values, out-of-focus values or crookedness values associated with the image 106.

If the mobile device 102 determines 306 that the camera block 108 is not capable of performing the image quality analysis, then the mobile device 102 may partition 310 the image 106 into bins. The mobile device 102 may then send 312 the partitioned image 106 to the GPU 110 for image quality analysis. Upon performing the image quality analysis, the GPU 110 may provide image quality metric values 112 for the analyzed image quality metrics 117.

The mobile device 102 may determine 314 whether there is a problem with the image 106. For example, the mobile device 102 may compare the image quality metric values 112 to image quality thresholds 118. This may be accomplished as described in connection with FIG. 1.

If there is no problem detected with the image 106, then the method 300 ends 316. If the mobile device 102 determines 314 that there is a problem with the image 106, the mobile device 102 may generate 318 a user notification 122 with problem areas highlighted on the image 106. The mobile device 102 may display the user notification 122 on a display screen 124 of the mobile device 102.

FIG. 4 is an example illustrating a user notification 422 generated according to the described systems and methods. An image 106 may be captured by a camera 104 of the mobile device 102. A camera block 108 or GPU 110 may automatically perform an image quality analysis for one or more pre-configured image quality metrics 117. In this example, the mobile device 102 determined that the image 106 is blurry.

The mobile device 102 may generate a user notification 422 that is displayed on a display screen 424. In this example, the user notification 422 is a pop-up message (e.g., push notification).

The user notification 422 may warn the user that a problem was found in the image 106. The user notification 422 may also include a description of the problem. In this case, the user notification 422 states that the problem is a “Blurry Image.”

The user notification 422 may include an option to retake the image 106. In this example, the user may select “OK” to retake the image 106. Alternatively, the user may disregard the user notification 422 by pressing “Cancel.”

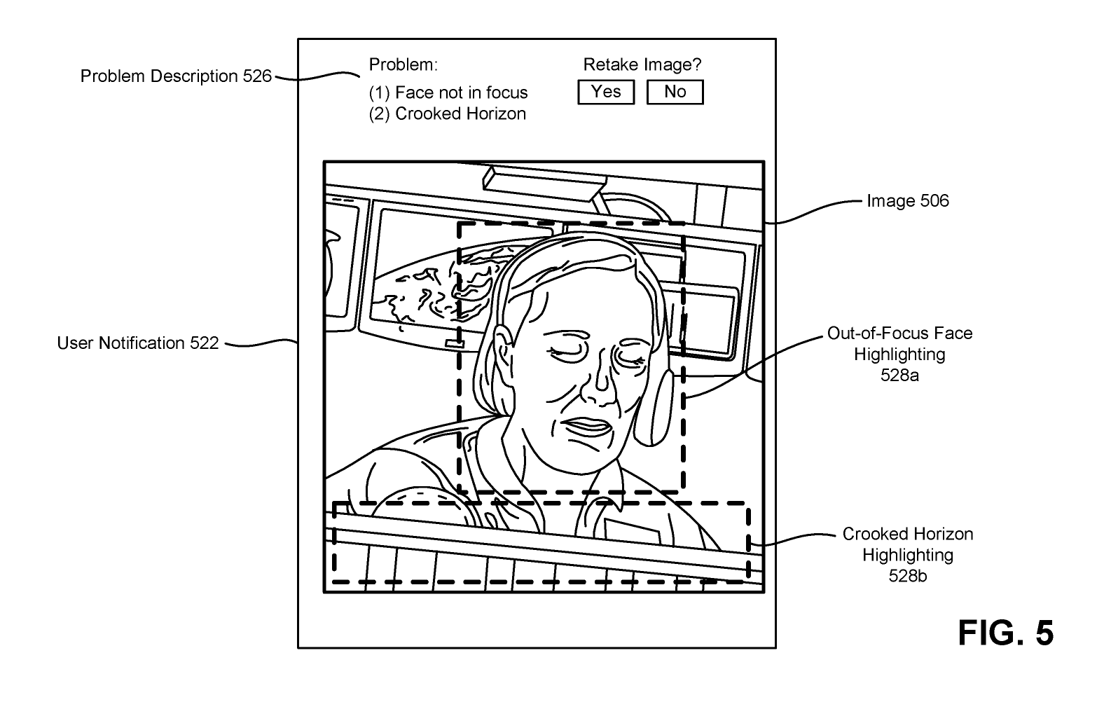

FIG. 5 is an example illustrating image quality analysis and a user notification 522 generated according to the described systems and methods. The image 506 may be captured by a camera 104 of the mobile device 102. A camera block 108 or GPU 110 may automatically perform an image quality analysis for one or more pre-configured image quality metrics 117. In this example, the mobile device 102 determined that there are problems with an out-of-focus face and a misaligned horizon.

The user notification 522 may be generated by a mobile device 102 based on the image quality analysis, as described in connection with FIG. 1. The user notification 522 may include a problem description 526 that describes what problems were found with the image 506. In this example, the problem description 526 states “(1) Face not in focus” and “(2) Crooked Horizon.”

In this example, the user notification 522 displays the image 506 that was captured. Including the image 506 in the user notification 522 may aid the user in reviewing the image 506 for problems.

The user notification 522 may also include highlighting 528 on the problem areas. In this example, the user notification 522 displays highlighting 528a on the out-of-focus face and highlighting 528b on the misaligned horizon. The highlighting 528 may aid the user in identifying the problem areas.

The user notification 522 may also include an option to retake the image 506. If a user chooses to retake the image 506 (e.g., pressing “Yes”), the mobile device 102 may bring up a camera software application and the user may recapture the image 506. Otherwise, the user may choose to disregard the user notification 522 (e.g., pressing “No”).

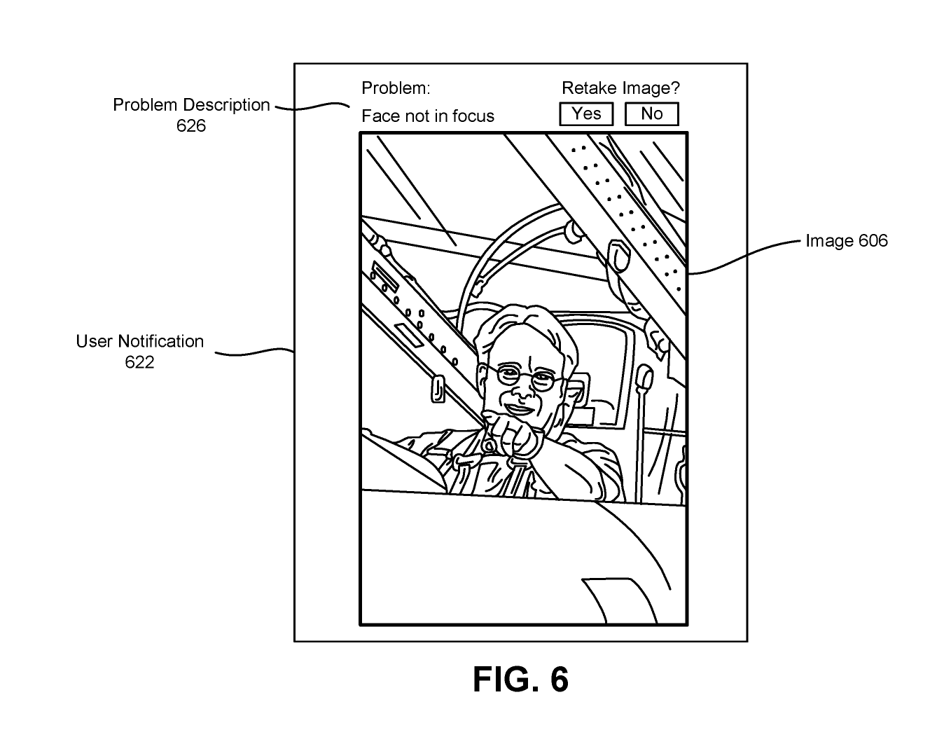

FIG. 6 is another example illustrating image quality analysis and a user notification 622 generated according to the described systems and methods. The image 606 may be captured by a camera 104 of the mobile device 102 and a camera block 108 or GPU 110 may automatically perform an image quality analysis for one or more pre-configured image quality metrics 117. In this example, the mobile device 102 identified a problem with an out-of-focus face.

The user notification 622 may be generated by a mobile device 102 based on the image quality analysis, as described in connection with FIG. 1. The user notification 622 may include a problem description 626 that describes what problems were found with the image 606. In this example, the problem description 626 states “Face not in focus.” It should be noted that in this example, the user notification 622 does not include highlighting 528 on the problem areas, as compared to FIG. 5. The user notification 622 may also include an option to retake the image 606 (e.g., pressing “Yes”) or disregard the user notification 622 (e.g., pressing “No”).

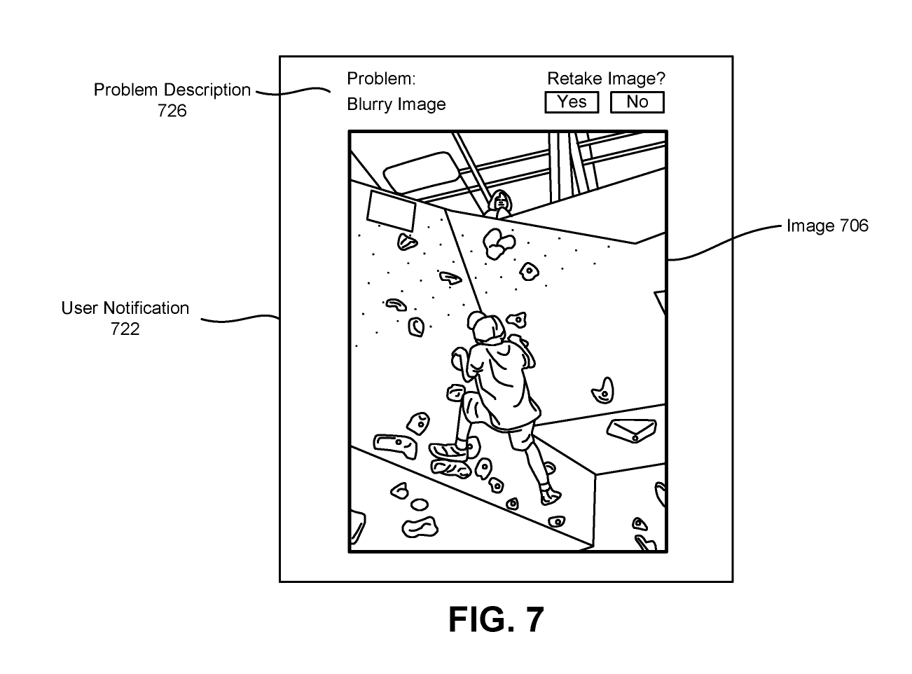

FIG. 7 is yet another example illustrating image quality analysis and a user notification 722 generated according to the described systems and methods. The image 706 may be captured by a camera 104 of the mobile device 102 and a camera block 108 or GPU 110 may automatically perform an image quality analysis for one or more pre-configured image quality metrics 117. In this example, the mobile device 102 identified that the image 706 is blurry.

In this example, the problem description 726 states “Blurry Image.” It should be noted that in this example, the user notification 722 does not include highlighting 528 on the problem areas, as compared to FIG. 5. The user notification 722 may also include an option to retake the image 706 (e.g., pressing “Yes”) or disregard the user notification 722 (e.g., pressing “No”).

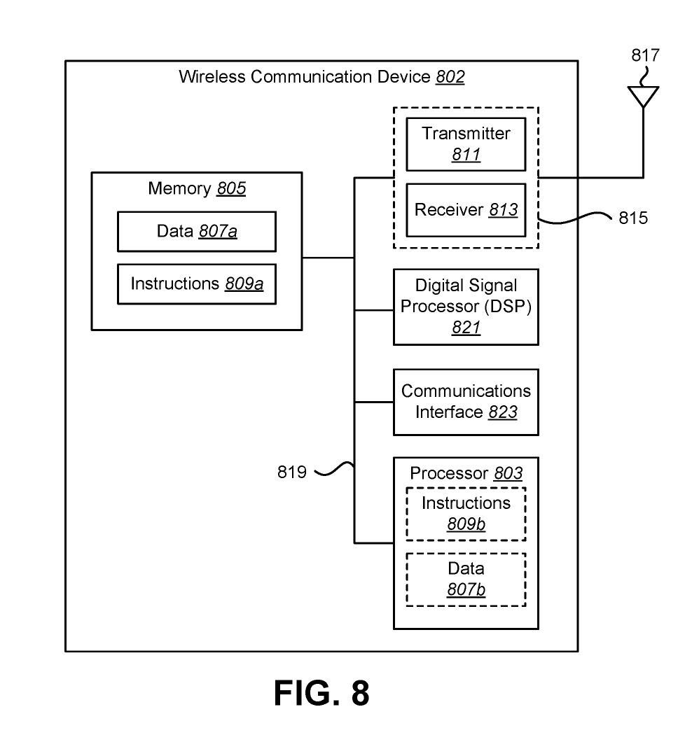

FIG. 8 illustrates certain components that may be included within a wireless communication device 802. The wireless communication device 802 described in connection with FIG. 8 may be an example of and/or may be implemented in accordance with the mobile device 102 described in connection with one or more of FIGS. 1-7.

The wireless communication device 802 includes a processor 803. The processor 803 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the wireless communication device 802 of FIG. 8, in an alternative configuration, a combination of processors (e.g., an ARM and DSP) could be used.

The wireless communication device 802 also includes memory 805 in electronic communication with the processor 803 (i.e., the processor can read information from and/or write information to the memory). The memory 805 may be any electronic component capable of storing electronic information. The memory 805 may be configured as random access memory (RAM), read-only memory (ROM), magnetic disk storage media, optical storage media, flash memory devices in RAM, on-board memory included with the processor, erasable programmable read-only (EPROM) memory, electrically erasable programmable read-only (EEPROM) memory, registers and so forth, including combinations thereof.

Data 807a and instructions 809a may be stored in the memory 805. The instructions 809a may include one or more programs, routines, sub-routines, functions, procedures, code, etc. The instructions 809a may include a single computer-readable statement or many computer-readable statements. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The wireless communication device 802 may also include a transmitter 811 and a receiver 813 to allow transmission and reception of signals to and from the wireless communication device 802 via an antenna 817. The transmitter 811 and receiver 813 may be collectively referred to as a transceiver 815. The wireless communication device 802 may also include (not shown) multiple transmitters, multiple antennas, multiple receivers and/or multiple transceivers.

The wireless communication device 802 may include a digital signal processor (DSP) 821. The wireless communication device 802 may also include a communications interface 823. The communications interface 823 may allow a user to interact with the wireless communication device 802.

The various components of the wireless communication device 802 may be coupled together by one or more buses, which may include a power bus, a control signal bus, a status signal bus, a data bus, etc. For the sake of clarity, the various buses are illustrated in FIG. 8 as a bus system 819.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
selecting a camera block or a graphics processing unit (GPU) to analyze an image for image quality upon capturing the image by a camera on a mobile device, wherein if the camera block is able to perform the image quality analysis, selecting the camera block to analyze the image for image quality, and selecting the GPU to analyze the image for image quality otherwise;
analyzing the image for image quality based on the camera block or GPU selection; and
generating a user notification upon detecting one or more problems with the image based on the image quality analysis.

2. The method of claim 1, wherein selecting a camera block or a GPU to analyze an image for image quality comprises querying the camera block to determine what image quality metrics the camera block supports.

3. The method of claim 2, wherein querying the camera block comprises:
sending an application program interface (API) call to the camera block; and
receiving a flag that indicates the image quality metrics the camera block supports.

4. The method of claim 1, wherein selecting a camera block or a GPU to analyze an image for image quality comprises checking a preconfigured lookup table that lists the image quality metrics the camera block can perform.

5. (canceled)

6. The method of claim 1, wherein analyzing the image comprises analyzing the image for at least one of blurriness, out-of-focus areas or a misaligned horizon in the image.

7. The method of claim 1, wherein the image quality analysis occurs as a background operation on the mobile device.

8. The method of claim 1, wherein generating the user notification comprises displaying a message that describes the one or more detected problems with the image.

9. The method of claim 1, wherein generating the user notification further comprises highlighting one or more areas of the image that are determined to have a problem.

10. The method of claim 1, wherein if the GPU is selected to analyze the image, the GPU analyzes the image for image quality using fast Fourier blurriness of the image.

11. The method of claim 1, wherein if the GPU is selected to analyze the image,
partitioning image data into bins; and
sending the bins the GPU to determine local blurriness associated with the bins.

12. The method of claim 1, further comprising performing corrections on the image for user approval based on the image quality analysis.

13. A mobile device, comprising:
a processor;
a memory in communication with the processor; and
instructions stored in the memory, the instructions executable by the processor to:
select a camera block or a graphics processing unit (GPU) to analyze an image for image quality upon capturing the image by a camera on the mobile device, wherein if the camera block is able to perform the image quality analysis, the instructions are executable to
select the camera block to analyze the image for image quality, and
select the GPU to analyze the image for image quality otherwise;
analyze the image for image quality based on the camera block or GPU selection; and
generate a user notification upon detecting one or more problems with the image based on the image quality analysis.

14. The mobile device of claim 13, wherein the instructions executable to select a camera block or a GPU to analyze an image for image quality comprise instructions executable to query the camera block to determine what image quality metrics the camera block supports.

15. The mobile device of claim 14, wherein the instructions executable to query the camera block comprise instructions executable to:
send an application program interface (API) call to the camera block; and
receive a flag that indicates the image quality metrics the camera block supports.

16. The mobile device of claim 13, wherein the instructions executable to select a camera block or a GPU to analyze an image for image quality comprise instructions executable to check a preconfigured lookup table that lists the image quality metrics the camera block can perform.

17. (canceled)

18. The mobile device of claim 13, wherein the instructions executable to generate the user notification comprise instructions executable to display a message that describes the one or more detected problems with the image.

19. The mobile device of claim 13, wherein the instructions executable to generate the user notification further comprise instructions executable to highlight one or more areas of the image that are determined to have a problem.

20. A computer-program product, the computer-program product comprising a non-transitory computer-readable medium having instructions thereon, the instructions comprising:
code for causing a mobile device to select a camera block or a graphics processing unit (GPU) to analyze an image for image quality upon capturing the image by a camera on the mobile device, wherein if the camera block is able to perform the image quality analysis, further comprising
code for causing the mobile device to select the camera block to analyze the image for image quality, and
code for causing the mobile device to select the GPU to analyze the image for image quality otherwise;
code for causing the mobile device to analyze the image for image quality based on the camera block or GPU selection; and
code for causing the mobile device to generate a user notification upon detecting one or more problems with the image based on the image quality analysis.

21. The computer-program product of claim 20, wherein the code for causing the mobile device to select a camera block or a GPU to analyze an image for image quality comprises code for causing the mobile device to query the camera block to determine what image quality metrics the camera block supports.

22. The computer-program product of claim 21, wherein the code for causing the mobile device to query the camera block comprises:
code for causing the mobile device to send an application program interface (API) call to the camera block; and
code for causing the mobile device to receive a flag that indicates the image quality metrics the camera block supports.

23. The computer-program product of claim 20, wherein the code for causing the mobile device to select a camera block or a GPU to analyze an image for image quality comprises code for causing the mobile device to check a preconfigured lookup table that lists the image quality metrics the camera block can perform.

24. (canceled)

25. The computer-program product of claim 20, wherein the code for causing the mobile device to generate the user notification comprises code for causing the mobile device to display a message that describes the one or more detected problems with the image.

26. An apparatus, comprising:
means for selecting a camera block or a graphics processing unit (GPU) to analyze an image for image quality upon capturing the image by a camera on a mobile device, wherein if the camera block is able to perform the image quality analysis, the apparatus further comprises
means for selecting the camera block to analyze the image for image quality, and
means for selecting the GPU to analyze the image for image quality otherwise;
means for analyzing the image for image quality based on the camera block or GPU selection; and
means for generating a user notification upon detecting one or more problems with the image based on the image quality analysis.

27. The apparatus of claim 26, wherein the means for selecting a camera block or a GPU to analyze an image for image quality comprise means for querying the camera block to determine what image quality metrics the camera block supports.

28. The apparatus of claim 27, wherein the means for querying the camera block comprise:
means for sending an application program interface (API) call to the camera block; and
means for receiving a flag that indicates the image quality metrics the camera block supports.

29. (canceled)

30. The apparatus of claim 26, wherein the means for generating the user notification comprise means for displaying a message that describes the one or more detected problems with the image.
